(19) United States
(12) Patent Application Publication
(10) Pub. No.: US 2016/0328791 A1
(43) Pub. Date: Nov. 10, 2016

(54) SYSTEM AND METHOD FOR ELECTRONIC CONSUMER DEBT VALIDATION AND DISPUTE PROCESS

(71) Applicant: GDR ACQUISITION COMPANY LLC, Wilmington, DE (US)

(72) Inventors: Mark Andrew Parsells, Wilmington, DE (US); Thomas D. Veale, Wilmington, DE (US); Robert Wilson Brown, Middletown, DE (US)

(21) Appl. No.: 15/145,985

(22) Filed: May 4, 2016

Related U.S. Application Data
(60) Provisional application No. 62/159,082, filed on May 8, 2015.

(51) Int. Cl. G06Q 40/00

(52) U.S. Cl. CPC G06Q 40/00

(57) ABSTRACT

A system and method for universal electronic consumer debt validation and dispute resolution permits consumers to access debt information and download related documents related to debt accounts for any type of debt. Moreover, debt owners or agencies may make available debt information for a consumer in a single repository so that a consumer may search and/or evaluate and download the information and initiate resolution of the debt as may be warranted.

### CROSS-REFERENCE TO RELATED APPLICATIONS

This application claims benefit and priority to U.S. Provisional Application No. 62/159,082, filed May 8, 2015, the disclosure of which is incorporated by reference herein in its entirety.

### BACKGROUND OF THE DISCLOSURE

1.0 Field of the Disclosure

The present disclosure relates to a method, a system and a computer program product for electronic consumer debt validation and dispute resolution, among other things.

2.0 Related Art

Consumer Debt disputes are common. Often consumers are unaware of any debt issues that may be pending, such as, e.g., collection proceedings and/or balances deemed overdue or collectable. Moreover, there appears to be a minimal centralized mechanism to permit consumers with charged-off accounts to communicate online with debt agencies such as banks, credit card companies and the like in a manner that can facilitate a reasonably timely resolution.

### SUMMARY OF THE DISCLOSURE

In one aspect, the present disclosure provides a method, a system and a computer program product for electronic consumer debt validation, among other things. The system may include an electronic platform that may enable the secure and controlled electronic creation, submission and response to consumer inquiries related to debt collection across multiple asset types. This system may provide a process to enable secure, timely and cost effective electronic transfer of validation requests and responses between a consumer and debt collector or debt owner.

In one aspect, the present disclosure provides a method, a system and a computer program product for enabling secure and controlled access and sharing of account level data and documents from multiple creditors and debt owners across multiple asset types for creditors, debt buyers, collection agencies and consumers. This may provide a consumer debt collection industry platform that enables universal secure access to information about non-performing or charged-off debt. For example, when accounts are charged-off they are typically removed from the creditor's online customer systems. If the account is placed with a third party collection agency or sold to a debt buyer, the consumer may not have access to supporting information to validate that the debt collector has a legitimate right to contact the consumer. The database provided by the system herein enables consumers, creditors and debt owners to continuously access and validate data and documents in a secure password protected environment.

In one aspect, a system for debt validation and dispute comprises a server comprising a computer and a consumer access subsystem and a debt validation subsystem, a database to store debt account information searchable and identifiable by a plurality of consumer debt account identifiers, the database searchable by the server and wherein the consumer access subsystem receives over a network a request related to the debt account from a consumer device coupled to the network, and the debt validation subsystem conveys the request and at least one consumer debt account identifier of the plurality of consumer debt account identifiers over the network to a device associated with a debt owner and coupled to the network for a response to the request for resolution of a debt dispute. The debt owner may comprise a collection agency. Also, the server may be configured to receive over the network an account information file from the debt owner and configured to create a data record in the database for each account specified in the account information file. The server may be configured to receive and validate credentials of a user and to send statements of account documents in the database to a user. The server may facilitate communication between a consumer and either a debt owner or a debt collector. The communication between the consumer and the debt owner or the debt collector may comprise a form that mimics or matches the templates stipulated by a regulatory agency. The debt validation subsystem may send an alert to the consumer device based on receipt of a document made available to the server by a collection agency or debt owner. The database may maintain debt account information including debt ownership information over time including changes in debt ownership.

In one aspect, a computer-implemented method for debt validation and dispute may comprise receiving a search request over a network at a server from a consumer device related to a consumer debt account, searching a database by the server to locate the consumer debt account, generating and displaying a form over the network to be completed by a consumer at a consumer device for initiating an inquiry or dispute with a debt owner or collection agency and sending by the server the completed form over the network to the debt owner or collection agency to resolve a dispute concerning the consumer debt account. The computer-implemented method may further comprise receiving a file over the network from a debt owner containing consumer debt account information and creating a data record in the database for each consumer debt account. Also, the computer-implemented method may further comprise receiving information at the server over the network from the debt owner or collection agency related to information contained in the completed form and updating a data record in the database. The computer-implemented method may further comprise making documents available by the server to the consumer device based on the received information from the debt owner or collection agency. The computer-implemented method may further comprise resolving a debt inquiry or dispute over the network between the consumer using the consumer device and the debt owner or collection agency, the resolution of the debt inquiry or dispute being recorded by the server at the database. The computer-implemented method may further comprise recording an ownership change related to debt associated with the consumer debt account.

In one aspect, a computer program product embodied on a non-transitory storage medium may be provided that, when read and executed by a computer, performs debt validation, the steps comprising receiving a search request over a network at a server from a consumer device related to a consumer debt account, searching a database by the server to locate the consumer debt account, generating and displaying a form over the network to be completed by a consumer at a consumer device for initiating an inquiry or dispute with a debt owner or collection agency and sending by the server the completed form over the network to the debt owner or collection agency to resolve an inquiry or dispute concerning the consumer debt account. The computer program product may further comprise receiving a file over the network from a debt owner containing consumer debt account information and creating a data record in the database for each consumer debt account. The computer program product may further comprise receiving information at the server over the network from the debt owner or collection agency related to information contained in the completed form and updating a data record in the database. Also, the computer program product may further comprise making documents available by the server to the consumer device based on the received information from the debt owner or collection agency. The computer program product may further comprise resolving a debt inquiry or dispute over the network between the consumer using the consumer device and the debt owner or collection agency, the resolution of the inquiry or dispute being recorded by the server at the database. The computer program product may further comprise recording an ownership change related to debt associated with the consumer debt account.

Additional features, advantages, and embodiments of the disclosure may be set forth or apparent from consideration of the detailed description and drawings. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 is a block diagram of an example computer-based system suitable for electronic consumer debt validation and dispute resolution, configured according to principles of the disclosure.

FIG. 2 is an example block diagram of software modules for a consumer access subsystem, configured according to principles of the disclosure.

FIG. 3 is an example block diagram of software modules for a debt validation subsystem, configured according to principles of the disclosure.

FIG. 4 is an example of a consumer access to debt accounts process, according to principles of the disclosure.

FIG. 5 is an example of a debt validation and dispute process, according to principles of the disclosure.

FIG. 6 is an example of a debt validation and dispute process, according to principles of the disclosure.

The present disclosure is further described in the detailed description that follows.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, cell phone, notebook computers, desktop computers, workstation computers, servers, or the like. Further, the computer may include an electronic device configured to communicate over a communication link. The electronic device may include, for example, but is not limited to, a mobile telephone, a personal data assistant (PDA), a mobile computer, a stationary computer, a smart phone, mobile station, user equipment, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. At least one application may include, but is not limited to, for example, an application program that can accept connections to service requests from clients by sending back responses to the clients. The database may be configured to run at least one application, often under heavy workloads, unattended, for extended periods of time with minimal human direction.

A “network”, as used in this disclosure, means an arrangement of two or more communication links. A network may include, for example, the Internet, a local area network (LAN), a wide area network (WAN), a metropolitan area network (MAN), a personal area network (PAN), a campus area network, a corporate area network, a global area network (GAN), a broadband area network (BAN), any combination of the foregoing, or the like. The network may be configured to communicate data via a wireless and/or a wired communication medium. The network may include any one or more of the following topologies, including, for example, a point-to-point topology, a bus topology, a linear bus topology, a distributed bus topology, a star topology, an extended star topology, a distributed star topology, a ring topology, a mesh topology, a tree topology, or the like.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, or the like. The communication link may bear various protocols such as TCP/IP, VOIP, or similar protocols. The communication link may be bi-directional.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-transitional media, non-volatile media and volatile media. Non-volatile media may include, for example, optical or magnetic disks and other persistent memory. Volatile media may include dynamic random access memory (DRAM). Transmission media may include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other non-transitory storage medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

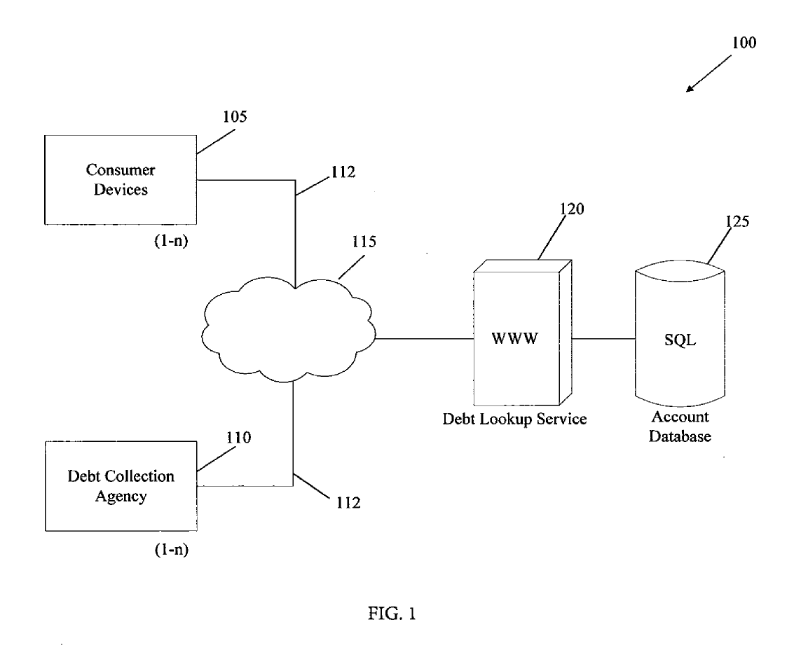

FIG. 1 is a block diagram of an example computer-based system 100 suitable for electronic consumer debt validation and dispute resolution, configured according to principles of the disclosure. The system 100 may comprise one or more consumer devices 105 that may be a device that includes a computer, such as, e.g., a mobile computing device, a personal computer, a tablet computer, or the like. The one or more devices 105 may be connected by a communication link 112 to a network 115, which may be the Internet, and to a debt lookup service computer 120, which may be a server. One or more debt agency devices 110, which may comprise a device that includes a computer, such as, e.g., a mobile computing device, a personal computer, a tablet computer, or the like, for use by a debt agency, a bank, a credit card company, or similar entity, may be connected by a communication link 112 to the network 115 and to the debt lookup service computer 120.

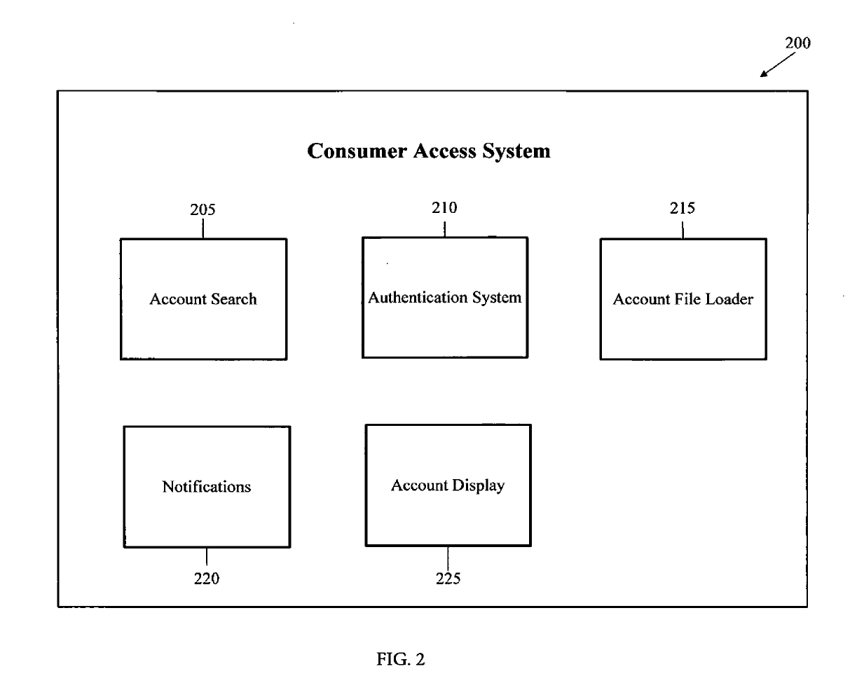

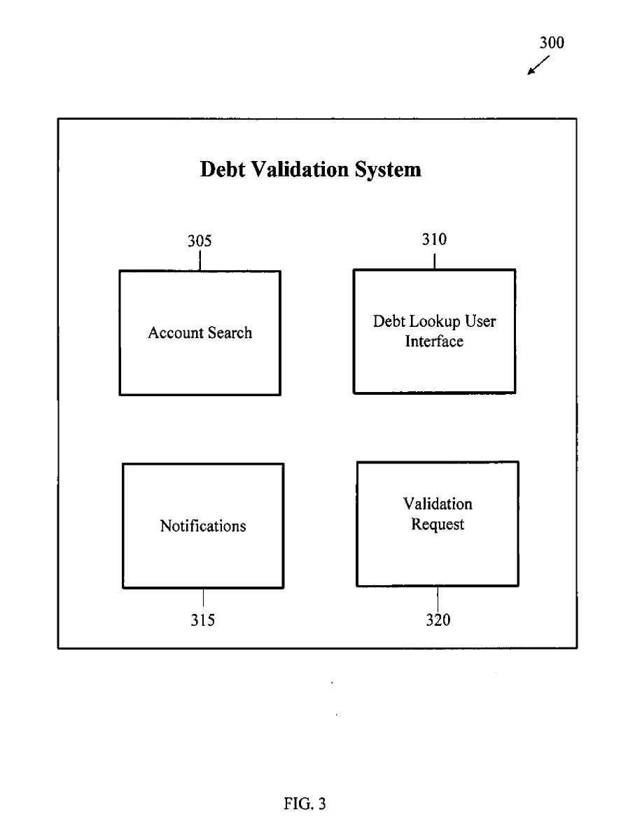

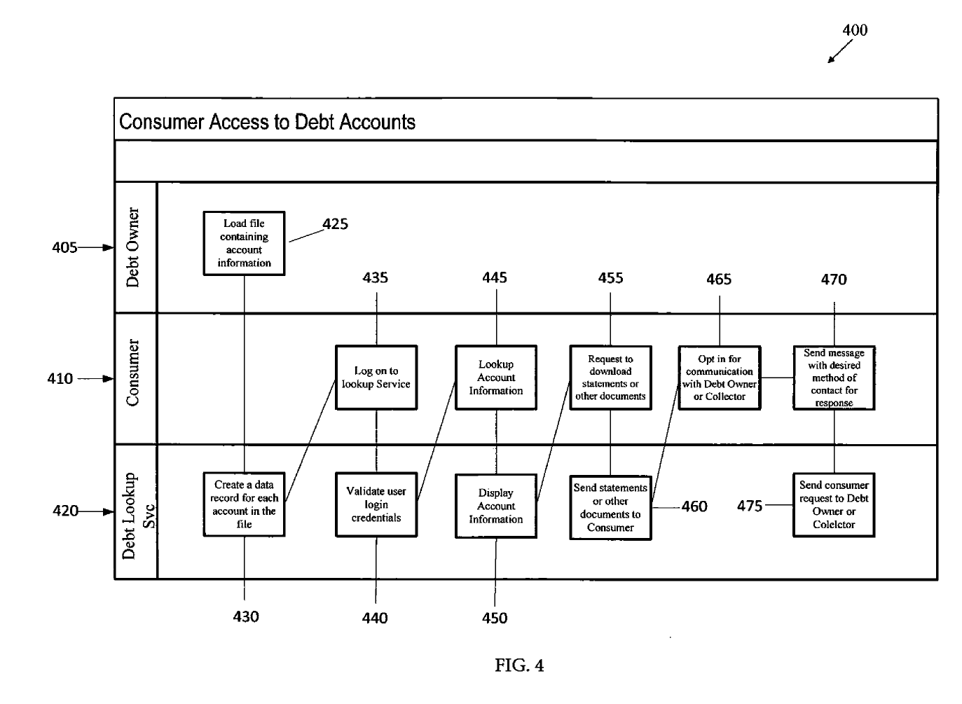

The debt lookup service computer 120 may be configured to communicate with consumers 410 via devices 105 and debt agencies via debt agency devices 110 over the network 115 in order to perform the services and steps described more fully below; in particular, certain steps described in relation to FIGS. 4-6. Moreover, the debt lookup service computer 120 may include several software components or modules executable by the debt lookup service computer 120, such as those software components described in relation to FIGS. 2 and 3. The debt lookup service computer 120 may communicate with an account database 125 to establish, maintain and correlate records of consumer accounts and debt agency information, as described more below. Account database 125 may store debt account information searchable and identifiable by a plurality of consumer debt account identifiers 126, which may be, e.g., account numbers.

FIG. 2 is an example block diagram of software modules for consumer access subsystem 200 for system 100, configured according to principles of the disclosure. These software modules 205, 210, 215, 220 and 225 may be configured to execute on the debt lookup service computer 120 and, perhaps, at least in part, on the one or more consumer devices 105. The consumer access subsystem 200 may include an account search module 205 that permits a consumer to enter identifying information related to a debt account, e.g., a credit card number, a loan number, or the like, and search database 125 to ascertain whether or not debt data is available related to a particular debt account(s), typically related to the particular consumer accessing the database 125 from device 105.

An authentication module 210 may be configured to authenticate a consumer in order to correctly associate the consumer with proper debt accounts. This may include verifying the consumer's identity via passwords, account number(s), social security number or part of a social security number, or other identifying information when accessing the system 100 and debt lookup service 120.

An account file loader 215 may be configured to accept and/or upload electronic file information related to consumer accounts from one or more validated debt agencies 110, or debt owners. For each account in the file, a data record may be created and retained in database 125 for the submission. Typically, this information includes account numbers (e.g., credit card accounts, loan numbers, or the like) along with debtor identification (e.g., name, address, social security numbers, or the like), and debt information such as balance, debt due date, payment information, and documents like account statements or agreements. The account file loader 215 may format information from various sources into a unified format for consistent information access and display. This information may be pre-loaded by the original creditor or debt owner or may be loaded in response to a consumer request for information.

A notifications module 220 may be configured to initiate communications to consumers such as through devices 105. Consumers may elect to initiate opt-in communication with debt owners or collectors. Communication may be controlled or managed by the debt look-up service 120 and may comprise a secure message based on a consumer's desired method of communication.

An account display module 205 may be configured to display information to a consumer in a normalized friendly format. A consumer may view and download any or all on-line records and documents concerning their debt, regardless of changes in ownership of the account, placement of the account to a third party collection agency or firms, or if the account has been extinguished, e.g., paid in full, settled in full, cancelled, or the like. A consumer may view a chain of debt ownership. A consumer can look up information on one or multiple accounts including different account types, accounts from multiple creditors, and accounts owned or collected by multiple debt owners or agencies.

The consumer access system 200 permits universal secure access to information about non-performing or charged-off debt. Debt may be centralized so that even if debt is placed with a third party or sold, a consumer has the ability to access supporting information to validate whether or not a debt collector has a legitimate right to contact the consumer.

The universal database 125 may permit consumers, creditors, and debt owners to continually access, update and/or validate data and documents in a secure password protected database 125 via the debt lookup service 120.

FIG. 3 is an example block diagram of software modules for a debt validation subsystem 300 for system 100, configured according to principles of the disclosure. Account search module 305 is similar to account search 205 and permits a consumer to search for information on consumer debt accounts. Debt lookup user interface 310 may be configured to receive and display debt and/or account information in a friendly user interface. The notifications module 315 may be configured to convey notification, alerts and communications to a debt agency and/or consumer, as described more fully below in relation to FIGS. 4-6. The validation request module 320 may be configured to process a validation request or dispute from a consumer.

FIG. 4 is an example of a consumer access to debt accounts process, the steps performed according to principles of the disclosure. In FIGS. 4-6, a debt owner or collection agency may be designated by equivalent reference numerals 405 or 615 (who may use device 110), a consumer may be designated by equivalent reference numerals 410, 505 or 605 (who may use device 105), and the debt lookup service may be designated by equivalent reference numerals 420, 510 or 610, which may be debt lookup service 120. Moreover, the steps of FIGS. 4-6 may also represent a block diagram of software components stored on a non-transitory storage medium that executes the corresponding steps when read and executed by a computer. The software components may be stored on computer-readable medium. Moreover, a computer program product may comprise the software components stored on a computer-readable medium that when read and executed by a computer, perform the action or actions related to the corresponding step.

The process 400 may involve a debt owner 405, a consumer 410, and the debt lookup service 420, which may be debt lookup service 120. At step 425, a debt owner 405 (which may be, e.g., debt agency 110) may upload a file through the network 115 which may contain account information related to one or more consumers. At step 430, the debt lookup service 120 may create a date record for each account contained in the uploaded file and stored in database 125. In some embodiments, this may include recording new ownership of the debt related to the account information. At step 435, a consumer 410 may log into the debt lookup service 420, such as over network 115 from a device 105. At step 440, the debt lookup service 420 may validate the user login of the consumer by checking log-in credentials such as, e.g., username and password. At step 445, the consumer may request to lookup account information, e.g., related to the logged-in consumer. At step 450, the debt lookup service 420 may display account information of one or more accounts that may be located on database 125. At step 455, the consumer 410 may request a download or display statements or other documents related to the consumer. At step 460, a statement or other documents may be sent to the consumer as requested. At step 465, the consumer 410 may opt-in for communication with the debt owners or collector. This may be a secure message that includes the consumer's desired method of contact for a response, such as at step 470. At step 475, the consumer's request may be sent to the debt owner or collector.

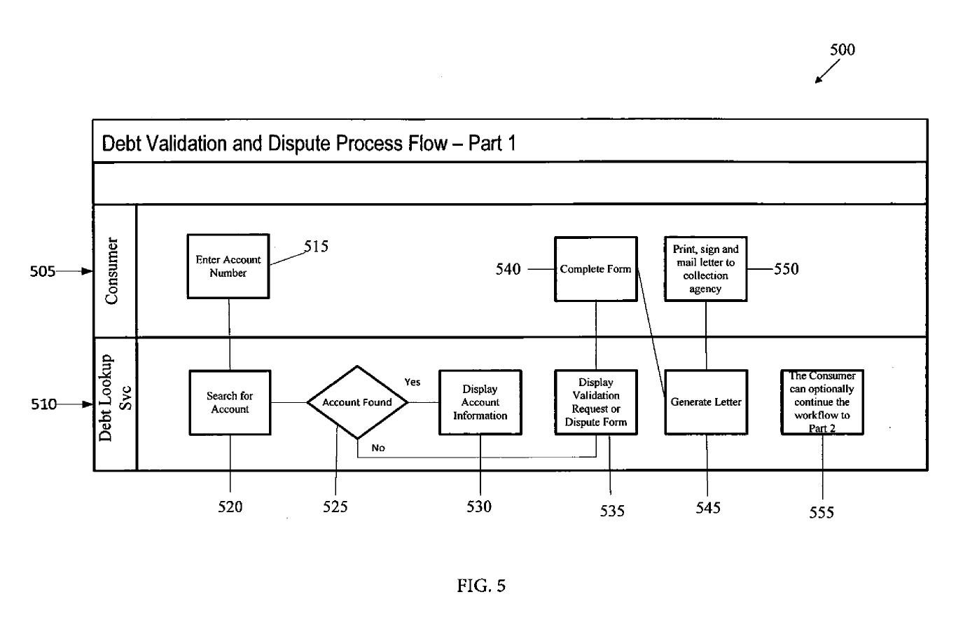

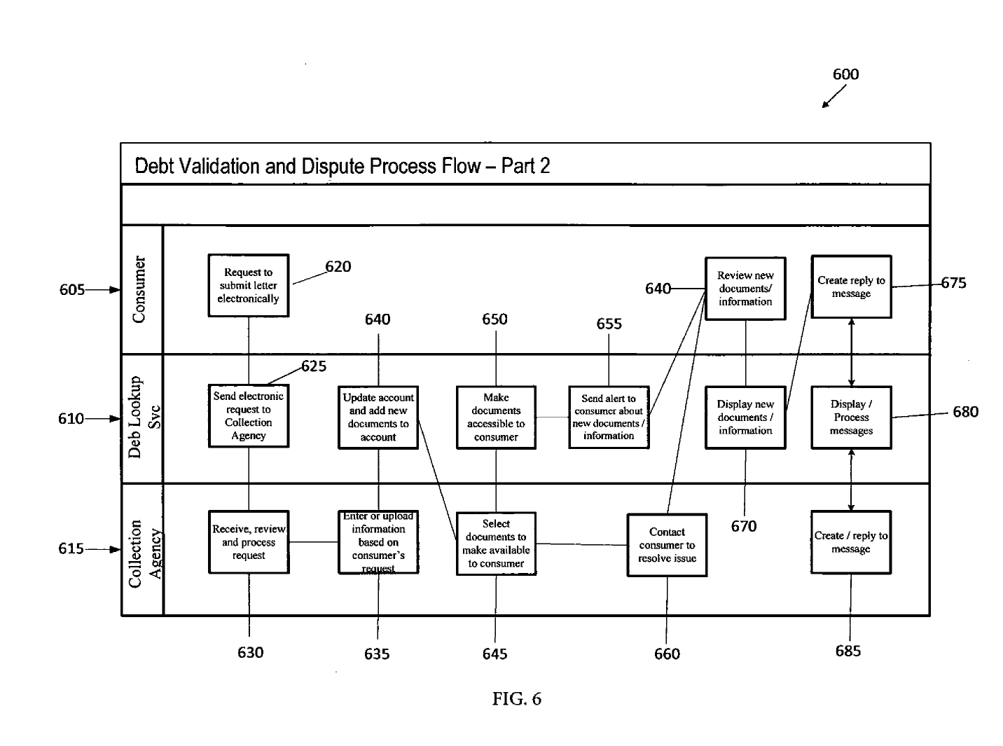

FIG. 5 is an example of a debt validation and dispute process, according to principles of the disclosure. The processes 500, 600 of FIGS. 5 and 6 may provide for a secure, timely and effective electronic transfer of validation requests and responses between a consumer and a debt collector or debt owner. The steps of FIGS. 5 and 6 may be done sequentially, simultaneously, and/or in parallel, as shown in the Figs. At step 515, a consumer (e.g., a consumer using device 105) may enter an account number (or identifier) related to a debt. At step 520, the debt lookup service 510 may search database 125 for records related to the entered account number. At step 525, a check is made to determine if records related to the account number has been found. If found, then at step 530, account information may be displayed to the consumer such as on device 105, and the process may stop. If, however, no account information has been found at step 535, a validation request form or a request for dispute form may be displayed to the consumer. The validation request or dispute letter/form mimics or matches the templates created by regulatory agencies in support of the Fair Debt Collection Practices Act and other regulatory requirements of a debt collector; which may be a physical or an electronic form. At step 540, the consumer may complete the form with pertinent account information sufficient to identify the account information being sought. At step 545, a letter may be generated for the consumer's signature for sending to the debt owner, collection agency or credit reporting agency. Typically, at step 550, this is mailed by the consumer via the postal service as typically required by law. The debt lookup service 510 may also alert the debt owner or agency 405, 615 electronically via network 115. At step 555, the process may end or may continue with the process of FIG. 6.

FIG. 6 is an example of a debt validation and dispute process, according to principles of the disclosure. The process of FIG. 6 may continue the process of FIG. 5. At step 620, a consumer 605 may request to have a dispute letter, such as disputing a debt, or have a validation letter sent electronically to a debt owner 405, credit reporting agency or collection agency 615. At step 625, the debt lookup service 610 receives the request from the consumer and may initiate sending of the dispute letter or validation letter (as completed by the consumer at step 540 of FIG. 5) to the debt owner or collection agency 615. At step 630, the debt owner or collection agency 615 may receive the electronic request and may process the request. At step 635, the debt owner or collection agency 615 may enter or upload debt account information based on the consumer 605 request. At step 640, the debt lookup service 610 may create, update and/or add new documents related to the consumer's account and/or request to database 125. At step 645, the debt owner or collection agency 615 may select documents to make available to the consumer. At step 650, the debt owner or collection agency 615 may make the selected documents available for access by the consumer 605. At step 655, an alert may be sent to the consumer 605 such as over the network 115 to device 105, to notify the consumer 605 of the availability of the documents. At step 660, the debt owner or collection agency 615 may contact the consumer to attempt to resolve the issue. At step 640, the consumer may receive new document(s) or information related to the account. At step 670, the debt lookup service 610 may display new documents or information as requested online by the consumer 605, perhaps to seek additional information. At step 675, the consumer may create a reply via debt lookup service 610 to the debt owner or collection agency 615. At step 680, the debt lookup service 610 may process the reply and forward same to the debt owner or collection agency 615. At step 685, the debt owner or collection agency 615 may create and respond to the message from the consumer 605. The server 120 may record any dispute resolution in database 125.

In one aspect, the processes of FIGS. 4-6 permit consumers to access a universal online database to search for information on consumer debt accounts. This may expedite transfer requests and return information for resolution of claims. This may save consumers and debt collectors the cost of mailing documents and may enhance security by replacing the printing and distribution of sensitive documents with a secure electronic delivery mechanism. The system and process herein enables multiple iterations of contact if more than one communication is required to resolve an issue or dispute between a consumer and a debt owner or collection agency. The debt owner may opt to make documents available immediately to a consumer, via the debt lookup service 120 and processes described herein.

The system 100 and methods herein may permit secure, independent access to data and documents, e.g., stored at database 125 on non-performing consumers from more than one creditor or debt owner, and may be a plurality of creditors or debt owners. Moreover, the system 100 may permit tracking and access to debt or debt accounts by the consumer when sold or assigned from one debt owner to another. Moreover, the database 125 may provide a permanent repository that may not be limited by statute of limitations. Further, the system 100 and methods herein may provide two-way secure sharing of confidential information (data and documents) between a debtor and a creditor including secure sharing by debt owners to associated authorized agencies or firms to support resolution of a dispute or debt.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed:

1. A system for debt validation and dispute, comprising:
a server comprising a computer and a consumer access subsystem and a debt validation subsystem;
a database to store debt account information searchable and identifiable by a plurality of consumer debt account identifiers, the database searchable by the server; and
wherein the consumer access subsystem receives over a network a dispute request related to the debt account from a consumer device coupled to the network, and the debt validation subsystem conveys the dispute request and at least one consumer debt account identifier of the plurality of consumer debt account identifiers over the network to a device associated with a debt owner and coupled to the network for a response to the dispute request for resolution of a debt dispute.

2. The system of claim 1, wherein the debt owner comprises a collection agency.

3. The system of claim 1, wherein the server is configured to receive over the network an account information file from the debt owner and configured to create a data record in the database for each account specified in the account information file.

4. The system of claim 1, wherein the server is configured to receive and validate credentials of a user and to send statements of account documents in the database to a user.

5. The system of claim 1, wherein the server facilitates communication between a consumer and either a debt owner or a debt collector.

6. The system of claim 5, wherein the communication between the consumer and the debt owner or the debt collector comprises a form that mimics or matches the templates stipulated by a regulatory agency.

7. The system of claim 1, wherein the debt validation subsystem sends an alert to the consumer device based on receipt of a document made available to the server by a collection agency or debt owner.

8. The system of claim 1, wherein the database maintains debt account information including debt ownership information over time including changes in debt ownership.

9. A computer-implemented method for debt validation and dispute, comprising:
receiving a search request over a network at a server from a consumer device related to a consumer debt account;
searching a database by the server to locate the consumer debt account,
generating and displaying a form over the network to be completed by a consumer at a consumer device for initiating a dispute with a debt owner or collection agency; and
sending by the server the completed form over the network to the debt owner or collection agency to resolve a dispute concerning the consumer debt account.

10. The computer-implemented method of claim 9, further comprising receiving a file over the network from a debt owner containing consumer debt account information and creating a data record in the database for each consumer debt account.

11. The computer-implemented method of claim 9, further comprising receiving information at the server over the network from the debt owner or collection agency related to information contained in the completed form and updating a data record in the database.

12. The computer-implemented method of claim 11, further comprising making documents available by the server to the consumer device based on the received information from the debt owner or collection agency.

13. The computer-implemented method of claim 12, further comprising resolving a debt dispute over the network between the consumer using the consumer device and the debt owner or collection agency, the resolution of the debt dispute being recorded by the server at the database.

14. The computer-implemented method of claim 9, further comprising recording an ownership change related to debt associated with the consumer debt account.

15. A computer program product embodied on a non-transitory storage medium that, when read and executed by a computer, performs debt validation and dispute, the steps comprising:
receiving a search request over a network at a server from a consumer device related to a consumer debt account;
searching a database by the server to locate the consumer debt account;
generating and displaying a form over the network to be completed by a consumer at a consumer device for initiating a dispute with a debt owner or collection agency; and
sending by the server the completed form over the network to the debt owner or collection agency to resolve a dispute concerning the consumer debt account.

16. The computer program product of claim 15, further comprising receiving a file over the network from a debt owner containing consumer debt account information and creating a data record in the database for each consumer debt account.

17. The computer program product of claim 15, further comprising receiving information at the server over the network from the debt owner or collection agency related to information contained in the completed form and updating a data record in the database.

18. The computer program product of claim 15, further comprising making documents available by the server to the consumer device based on the received information from the debt owner or collection agency.

19. The computer program product of claim 15, further comprising resolving a debt dispute over the network between the consumer using the consumer device and the debt owner or collection agency, the resolution of the debt dispute being recorded by the server at the database.

20. The computer program product of claim 15, further comprising recording an ownership change related to debt associated with the consumer debt account.
